(19) United States
(12) Patent Application Publication
(10) Pub. No.: US 2017/0146427 A1
(43) Pub. Date: May 25, 2017

(54) OPTICAL WAVEFRONT MEASURING DEVICE AND METHOD

(71) Applicant: UMA Technology Inc., Jubei City (TW)

(72) Inventor: Jen Sheng LIANG, Jubei City (TW)

(21) Appl. No.: 15/298,842

(22) Filed: Oct. 20, 2016

(30) Foreign Application Priority Data
Nov. 20, 2015 (TW) 104138552

(51) Int. Cl. G01M 11/02; G02B 27/30

(52) U.S. Cl. CPC G01M 11/0257; G01M 11/0214; G02B 27/30

(57) ABSTRACT

In an optical wavefront measuring device, a SLM generates a plurality of different through holes, so that light beams pass through the through holes and form a plurality of light patterns. The distance between an infinite objective lens module and a test lens is adjusted so that the light patterns enter into a wavefront sensor in the form of approximately parallel light after passing through the infinite objective lens module and the test lens. The wavefront sensor captures a plurality of WS images which do not have a fold-over phenomenon according to the light patterns. Computer by using an algorithm to obtain wavefront change information, and then reconstructs a wavefront on the basis of the wavefront change information.

This application claims priority of No. 104138552 filed in Taiwan R.O.C. on Nov. 20, 2015 under 35 USC 119, the entire content of which is hereby incorporated by reference.

### BACKGROUND OF THE INVENTION

Field of the Invention

The present invention relates to an optical wavefront measuring device and a method thereof, and more particularly to an optical wavefront measuring device and a method thereof using a SLM generates and a wavefront stitching technique to prevent light spots from generating a fold-over and to rebuild a wavefront having high aberration.

Related Art

Taking into consideration a large number of lenses are used in a variety of optical products, the skilled artisans pay a great deal of attention to how to quickly and accurately detect the optical quality of the lens. The wavefront of a lightwave is the locus of points characterized by propagation of position of the same phase, that is, the points have the same propagation distances from the light source generating the lightwave. Shack-Hartmann wavefront sensor (SHWS), as disclosed by U.S. Pat. No. 4,141,652, has advantages of low cost, simple structure, high measurement speed and low requirements for environmental vibration, so that it has been used in wavefront measuring.

FIGS. 1(a) and 1(b) show a schematic view of a Shack-Hartmann wavefront sensor and the wavefront of a lightwave. As shown in FIGS. 1(a) and 1(b), a Shack-Hartmann wavefront sensor 100 comprises a lens array 110 and an image sensor 120. The lightwave shown in FIG. 1(a) has the same phase. FIG. 1(b) shows a lightwave in which lateral variations of wavefront occur.

According to the Shack-Hartmann wavefront sensor 100, the lateral variations of wavefront are equal to the lateral offset of spots divided by the focal length of the lens. Then, the Zernike polynomial may be used to rebuild the wavefront. More specifically, Zernike polynomial coefficients are obtained in advanced, and then the coefficients are substituted into the Zernike polynomial to rebuild the wavefront. Regarding to the algorithm, [“History and principle of Shack-Hartmann Wavefront Sensing,” Refractive Surgery Journal, September/October, 2001, Vol. 17] and [“Modal wavefront estimation from phase derivative measurements,” J. Opt. Soc. Am. July, 1979, Vol. 69, Issue 7, pp. 972-977] are listed for the purpose of reference.

FIG. 2 is a schematic illustration of two spots folded over at the corresponding location, onto which the two spots with optical phase differences are focused by a same lens array. The wavefront having large phase differences is prone to produce a fold-over phenomenon. The lateral offset of spots folded over cannot be calculated since the spots folded over cannot be distinguished. As a result, a number of techniques have been proposed for this problem, for example Taiwan Patent Application Nos. 095146676 and 09127215 and U.S. Pat. Nos. 4,141,652 and 7,414,712, the entire content of which is hereby incorporated by reference.

However, a general optical element, such as lens, or system whose pupil is circular and whose related properties is distributed symmetrically to the axis, so that when the techniques are applied to aspherical lens, there is still room for improvement. In order to effectively solve the problem of identification of lateral offset under large phase difference, we provide an improved optical wavefront measuring device and method which are suitable for measuring the wavefront of an optical lens or system having a large phase difference.

### SUMMARY OF THE INVENTION

An objective of the present invention is to provide an optical wavefront measuring device and method. Another objective of the present invention is to provide an optical wavefront measuring device and method using a SLM generates and a wavefront stitching technique to prevent light spots from generating a fold-over and to rebuild a wavefront having high aberration.

According to one embodiment of the present invention, an optical wavefront measuring device for testing a lens under test comprises a spatial light modulator (SLM), a wavefront sensor, an infinite objective lens module and a computer. The SLM is used to produce different apertures, whereby different light beams passing through the different apertures form light patterns. The infinite objective lens module is used to adjust the distance between the infinite objective lens module and the lens under test, whereby the light patterns passing through the lens under test and the infinite objective lens module become approximately parallel and then enter into the wavefront sensor. The wavefront sensor is used to capture WS images on the basis of the light patterns, wherein the WS images do not have a fold-over phenomenon. The computer is used to stitch the WS images by using an algorithm to obtain a wavefront variation information, and then to rebuild a complete wavefront on the basis of the wavefront variation information.

In one embodiment, the optical wavefront measuring device further comprises a parallel light source system used for generating the light beams being parallel.

In one embodiment, the infinite objective lens module comprises an infinite objective lens and an actuator. The light patterns sequentially pass through the infinite objective lens module and the lens under test. The light patterns passing through the infinite objective lens form a plurality of focused spots. The actuator is used to adjust the distance between the infinite objective lens and the lens under test, so that the focused spots are focused at the focal length of the lens under test.

In one embodiment, the infinite objective lens module comprises an infinite objective lens and an actuator. The light patterns sequentially pass through the lens under test and the infinite objective lens module. The light patterns passing through the lens under test form a plurality of focused spots. The actuator is used to adjust the distance between the infinite objective lens and the lens under test, so that the focused spots are focused at the focal length of the infinite objective lens.

In one embodiment, the algorithm is a phase stitching algorithm (PSA), a gradient stitching algorithm (GSA) or a least-square fitting (LSF).

In one embodiment, the apertures include a circular aperture and a first annular aperture being concentric with each other. In one embodiment, the inside diameter of the first annular aperture is not larger than the diameter of the circular aperture. In one embodiment, the apertures further include a second annular aperture being concentric with the first annular aperture. The inside diameter of the second annular aperture is not larger than the outside diameter of the first annular aperture.

According to one embodiment of the present invention, an optical wavefront measuring method for testing a lens under test, the method comprising: using a SLM to produce different apertures, whereby different light beams passing through the different apertures form a plurality of light patterns; using an infinite objective lens module to adjust the distance between the infinite objective lens module and the lens under test, whereby the light patterns passing through the lens under test and the infinite objective lens module become approximately parallel and then enter into a wavefront sensor; using a wavefront sensor to capture a plurality of WS images on the basis of the light patterns, wherein the WS images do not have a fold-over phenomenon; and using a computer to stitch the WS images by using an algorithm to obtain a wavefront variation information, and then to rebuild a complete wavefront on the basis of the wavefront variation information.

In one embodiment, the apertures include a circular aperture and a first annular aperture being concentric with each other. The step of using a SLM to produce different apertures comprises: increasing the diameter of the circular aperture by increments of Δr at each step until n-th step at which the WS image corresponding to the circular aperture has a fold-over phenomenon, and setting the diameter of the circular aperture to be the diameter φₙ₋₁ at (n-1)-th step; setting the inside diameter A₀ of the first annular aperture to be not larger than the diameter φₙ₋₁ of the circular aperture; and increasing the outside diameter of the first annular aperture by increments of Δr at each step until i-th step at which the WS image corresponding to the first annular aperture has a fold-over phenomenon, and setting the outside diameter of the first annular to be the diameter Aᵢ₋₁ at (i-1)-th step.

In one embodiment, the apertures further include a second annular aperture being concentric with the first annular aperture. The step of using a SLM to produce different apertures further comprises: setting the inside diameter 2A₀ of the second annular aperture to be not larger than the outside diameter A of the first annular aperture, and increasing the outside diameter of the second annular aperture by increments of Δr at each step until I-th step at which the WS image corresponding to the second annular aperture has a fold-over phenomenon, and setting the outside diameter of the second annular to be the diameter 2A_{I-1} at (I-1)-th step.

In one embodiment, the algorithm is a phase stitching algorithm (PSA), a gradient stitching algorithm (GSA) or a least-square fitting (LSF).

According to one embodiment of the present invention, different WS images without a fold-over phenomenon are obtained; the wavefronts from the WS images are stitched; the wavefront aberrations after stitching are obtained; then a complete wavefront can be rebuilt. As a result, the problem of the fold-over phenomenon can be resolved, which occurs under high aberrations due to lateral displacement, so that the optical wavefront measuring device and method of the present invention are suitable for testing an aspherical lens.

### BRIEF DESCRIPTION OF THE DRAWINGS

The foregoing features, aspects, and advantages of the present disclosure will now be described with reference to the drawings of preferred embodiments that are intended to illustrate and not to limit the disclosure.

FIGS. 1(a) and 1(b) are schematic illustrations of a Shack-Hartmann wavefront sensor and the wavefront of a lightwave.

FIG. 2 is a schematic illustration of two spots folded over at the corresponding location, onto which the two spots with optical phase differences are focused by a same lens array.

FIG. 3 is a schematic illustration of an optical wavefront measuring device according to an embodiment of the present invention.

FIG. 4 is a schematic illustration of an optical wavefront measuring device according to another embodiment of the present invention.

FIG. 5 is a schematic illustration of a fold-over phenomenon.

FIG. 6 is a schematic illustration of a circular φₙ₋₁ WS images without a fold-over phenomenon.

FIG. 7 is a schematic illustration of a first annular Aᵢ₋₁ WS images without a fold-over phenomenon.

FIG. 8 is a schematic illustration of a second annular 2A_{I-1} WS images without a fold-over phenomenon.

FIG. 9 is a schematic illustration of the distribution of the size of different apertures.

FIG. 10(A) is a schematic illustration of the variation of different wavefronts before the wavefronts are stitched.

FIG. 10(B) is a schematic illustration of the whole wavefront variation information after the wavefronts of FIG. 10(A) are stitched.

FIG. 11 is a schematic illustration of the rebuilded wavefront obtained by using the whole wavefront variation information in FIG. 10(B).

FIG. 12(A) is a flow chart of an optical wavefront measuring method according to an embodiment of the present invention.

FIG. 12(B) is a flow chart of an optical wavefront measuring method according to an embodiment of the present invention.

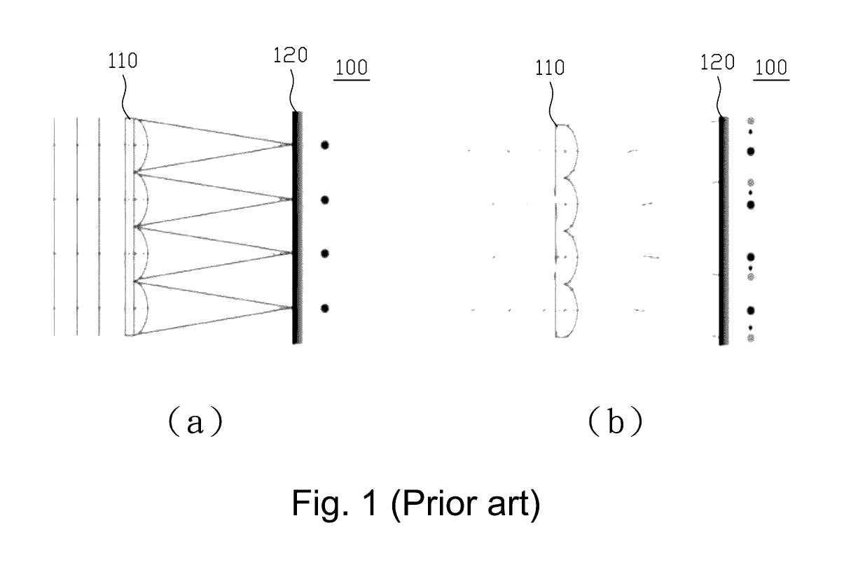

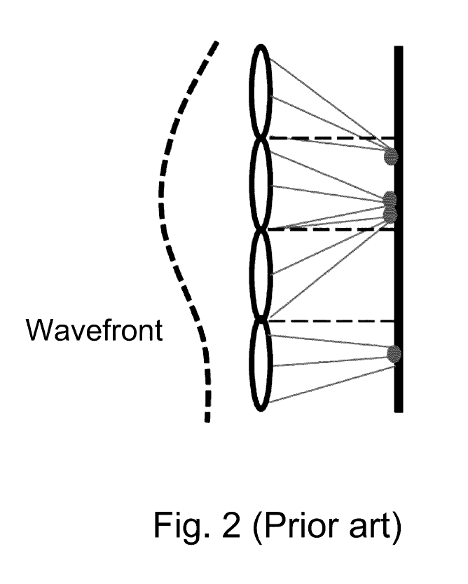

### DETAILED DESCRIPTION OF THE INVENTION

These and other embodiments of the present disclosure will also become readily apparent to those skilled in the art from the following detailed description of preferred embodiments having reference to the attached figures; however, the disclosure is not limited to any particular embodiment(s) disclosed herein. Accordingly, the scope of the present disclosure is intended to be defined only by reference to the appended claims.

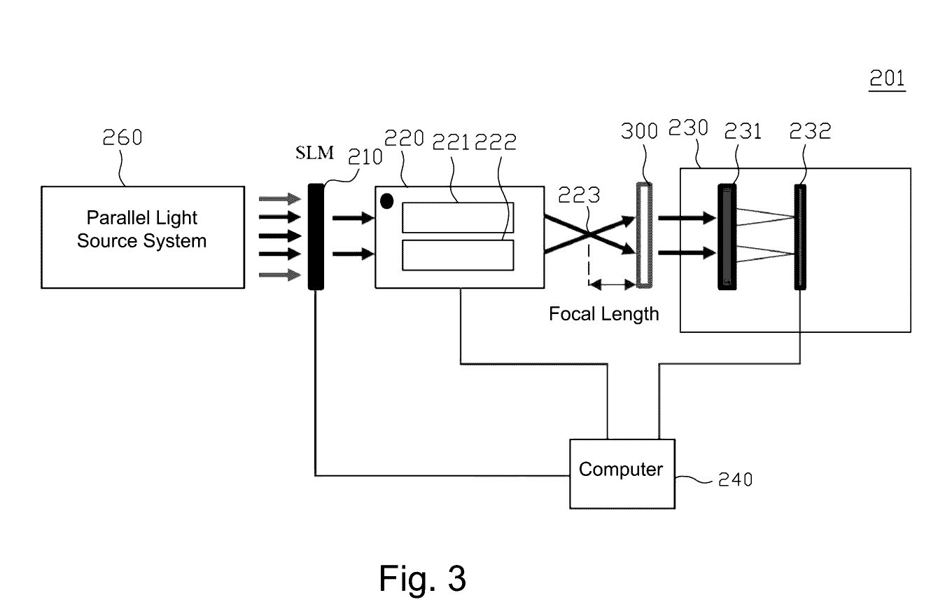

FIG. 3 is a schematic illustration of an optical wavefront measuring device according to an embodiment of the present invention. As shown in FIG. 3, an optical wavefront measuring device 201 used to test a lens 300 comprises a spatial light modulator (SLM) 210, an infinite objective lens module 220, a wavefront sensor 230 and a computer 240. In one embodiment, the optical wavefront measuring device 201 may further comprise a parallel light source system 260 used for generating a parallel light. The SLM 210 is used to produce different apertures having different dimensions at different times. The apertures may be circular holes or annular holes and are adapted to transmit parallel light to form light patterns being circular or annular. The SLM 210 may be in the mode of penetrant architecture such as LCD, and also may be in the mode of reflective architecture such as LCOS and DMD etc. According to an embodiment of the present invention, different parallel light beams generated by a time-sharing manner become or form different light patterns after they pass through different apertures at different times. Hereinafter, the operation method at a certain time point will be described.

After the light patterns pass through the infinite objective lens module 220 and lens under test 300, a WS (wavefront sensor) image is formed in the wavefront sensor 230. The wavefront sensor 230 captures the WS image and transmits it to the computer 240. The light pattern would be focused by the infinite objective lens module 220 and lens under test 300 to form a focused spot 223. The distance between the focused spot 223 (or the infinite objective lens module 220) and the lens under test 300 is adjusted, so that the light pattern can enter into the wavefront sensor 230 in a form of parallel light. The computer 240 performs wavefront calculation on the WS images to obtain a desired wavefront.

More specifically, in the embodiment of FIG. 3, the light pattern enters into the wavefront sensor 230 after passing through the infinite objective lens module 220 and the lens under test 300, sequentially. The infinite objective lens module 220 includes an infinite objective lens 221 and a Z-axis actuator 222. The light pattern passing through the infinite objective lens 221 forms the focused spot 223. The Z-axis actuator 222 adjusts the distance between the focused spot 223 and the lens under test 300, so that the light pattern can enter into the wavefront sensor 230 in a form of parallel light. That is, after the focused spot 223 is focused at the focal length of the lens under test 300, the light pattern can enter into the wavefront sensor 230 in a form of parallel light.

The wavefront sensor 230 comprises a lens array 231 and an image sensor 232. After passing through the lens array 231, the light pattern enters into the image sensor 232. The image sensor 232 obtains the WS image and then transmits it into the computer 240.

the computer 240 is used to control the SLM 210, the infinite objective lens module 220 and the wavefront sensor 230, to capture the WS image, to adjust the focal length, to analyze the spots folded over, to conduct stitching (described later), to perform wavefront calculation on the WS images, so that a desired wavefront can be obtained.

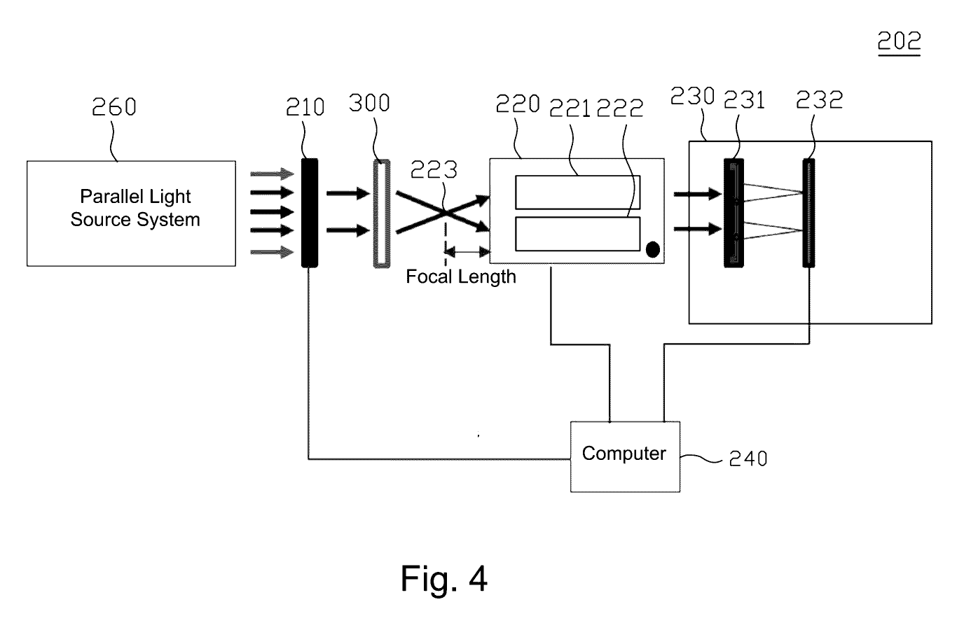

FIG. 4 is a schematic illustration of an optical wavefront measuring device according to another embodiment of the present invention. The embodiment of FIG. 4 is similar to the embodiment of FIG. 3, and therefore the elements in FIG. 4 having the same function as those in FIG. 3 are assigned with the same reference numerals, and redundant explanations thereof are omitted herein. Only the difference will be described in the following. As shown in FIG. 4, after passing through the lens under test 300 and the infinite objective lens module 220, sequentially, the light pattern enters into the wavefront sensor 230. The light pattern passing through the lens under test 300 forms a focused spot 223. The Z-axis actuator 222 adjusts the distance between the focused spot 223 and the infinite objective lens 221, so that the light pattern can enter into the wavefront sensor 230 in a form of parallel light. That is, after the focused spot 223 is focused at the focal length of the infinite objective lens 221, the light pattern can enter into the wavefront sensor 230 in a form of parallel light.

The stitching method used to solve the problem that spots fold over will be described in the following.

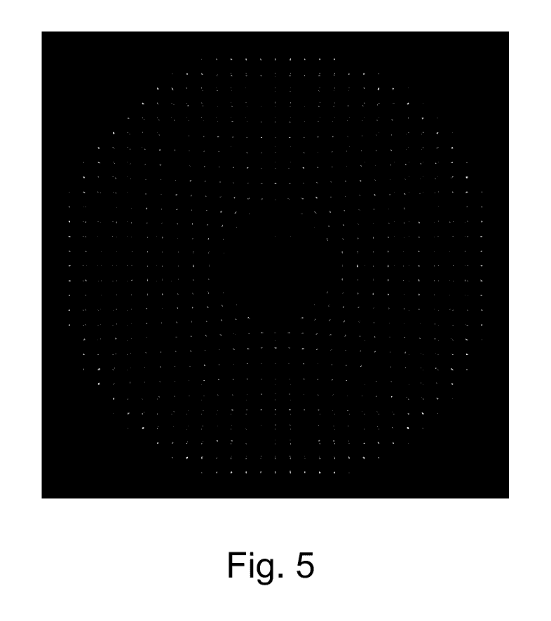

FIG. 5 is a schematic illustration of a fold-over phenomenon. As shown in FIG. 5, after parallel light pass through the SLM and the whole pupil of the lens under test, the fold-over phenomenon occurs because the lens under test has a large phase difference.

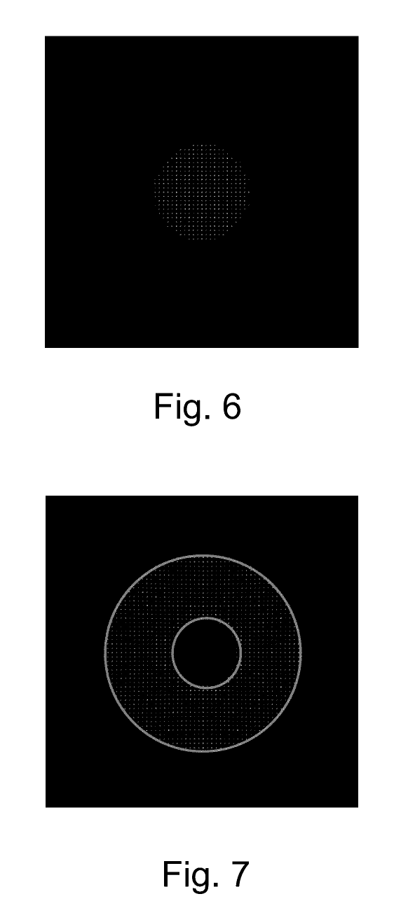

FIG. 6 is a schematic illustration of a circular φₙ₋₁ WS images without a fold-over phenomenon. The test processes for overcoming the fold-over phenomenon are described in the following. A circular aperture having a diameter cp is generated by the SLM 210. The diameter φₙ₋₁ is increased by increments of Δr at each step and then the wavefront is optimized by adjusting the focal length of the Z-axis until n-th step at which a fold-over phenomenon occurs. In an embodiment, it may be further confirmed that whether there is not a change between two WS images of diameter φₙ and diameter φₙ₋₁ (as described later). The SLM 210 stops increasing the diameter of the aperture, and then switches the diameter from φₙ to φₙ₋₁. The wavefront sensor 230 captures the WS image of diameter φₙ₋₁ and the computer 240 records the WS image of diameter φₙ₋₁ (hereafter called “φₙ₋₁ WS image”). φₙ₋₁ WS image is shown in FIG. 6.

During the processes, if the SLM 210 increases the diameter of the aperture at a certain step where there is not a change between the former and latter WS images, one can confirm that the lens 300 has the biggest pupil at that certain step and then stops increasing the diameter of the aperture.

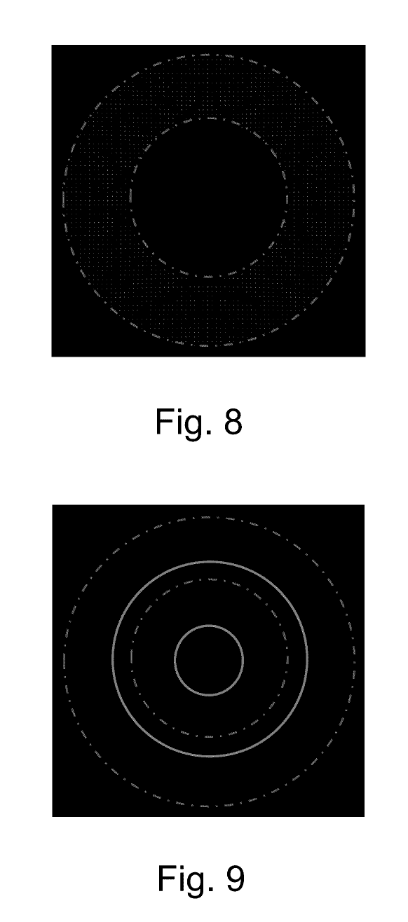

FIG. 7 is a schematic illustration of a first annular Aᵢ₋₁ WS images without a fold-over phenomenon. The inside diameter A₀ of a first annular aperture having a diameter φₙ₋₁ serves as a starting point. The outside diameter of the first annular aperture is increased by increments of Δr at each step and then the wavefront is optimized by adjusting the focal length of the Z-axis until i-th step at which a fold-over phenomenon occurs. In an embodiment, it may be further confirmed that whether there is not a change between two WS images of the outside diameters Aᵢ and Aᵢ₋₁ (as described later). The SLM 210 stops increasing the outside diameter of the first annular aperture, and then switches the outside diameter from Aᵢ to Aᵢ₋₁. The wavefront sensor 230 captures the WS image of the first annular aperture having outside diameters Aᵢ₋₁ (hereafter called “Aᵢ₋₁ WS image”), and the computer 240 records Aᵢ₋₁ WS image of the first annular. Aᵢ₋₁ WS image is shown in FIG. 7.

During the processes, if the SLM 210 increases the outside diameter of the first annular aperture at a certain step where there is not a change between the former and latter WS images, one can confirm that the lens 300 has the biggest pupil at that certain step and then stops increasing the outside diameter. In an embodiment, the inside diameter A₀ may be smaller than diameter φₙ₋₁. For example, A₀=φₙ₋₁−m*Δr. The value of m corresponds to the size of the overlap region and may be determined by the kind of the stitching technique. When m=0, there is not an overlap region.

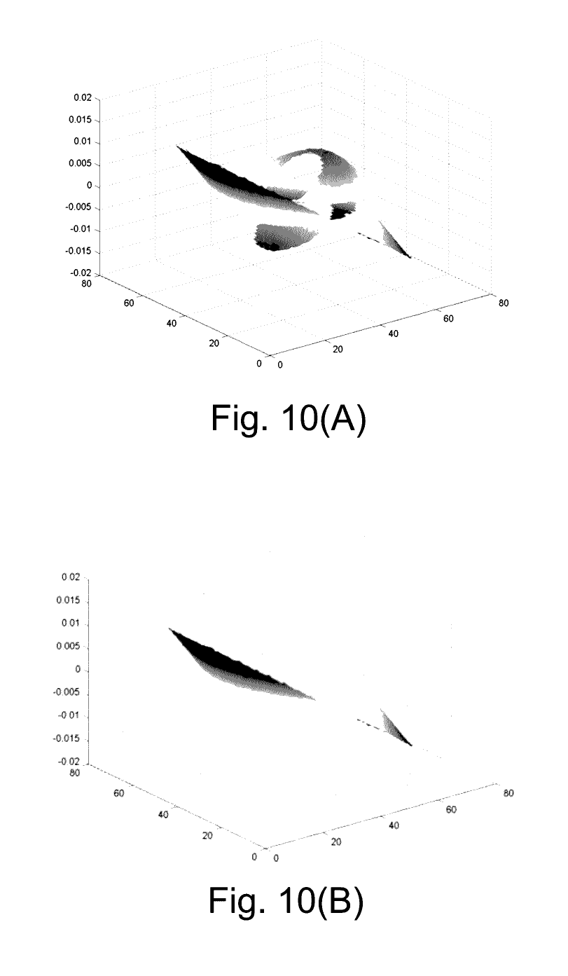

FIG. 8 is a schematic illustration of a second annular 2A_{I-1} WS images without a fold-over phenomenon. The outside diameter Aᵢ₋₁ of the first annular aperture serves as the inside diameter 2A₀ of a second annular aperture. The outside diameter of the second annular aperture is increased by increments of Δr at each step and then the wavefront is optimized by adjusting the focal length of the Z-axis until n-th step at which a fold-over phenomenon occurs. In an embodiment, it may be further confirmed that whether there is not a change between two WS images of the outside diameters 2A_{I} and 2A_{I-1} (as described later). The SLM 210 stops increasing the outside diameter of the second annular aperture, and then switches the outside diameter from 2A₁ to 2A_{I-1}. The wavefront sensor 230 captures the WS image of the second annular aperture having outside diameter 2A_{I-1} (hereafter called “2A_{I-1} WS image”), and the computer 240 records 2A_{I-1} WS image of the second annular. 2A_{I-1} WS image is shown in FIG. 8.

During the processes, if the SLM 210 increases the outside diameter of the second annular aperture at a certain step where there is not a change between the 2A_{I} and 2A_{I-1} WS images, it is confirmed that the lens 300 has the biggest pupil at that certain step and then stops increasing the outside diameter. In an embodiment, the inside diameter 2A₀ is smaller than the outside diameter Aᵢ₋₁ of the first annular aperture. For example, 2A₀=Aᵢ₋₁−m*Δr. The value of m corresponds to the size of the overlap region and may be determined by the kind of the stitching technique. When m=0, there is not an overlap region.

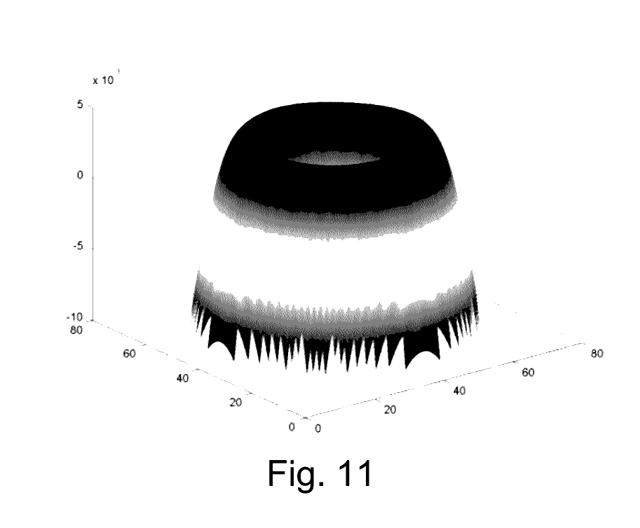

FIG. 9 is a schematic illustration of the distribution of the size of different apertures. As shown in FIG. 9, the above-mentioned processes are repeated to obtain a plurality of WS images without a fold-over phenomenon. The WS images comprise a φₙ₋₁ WS image, a Aᵢ₋₁ WS image, a 2A_{I-1} WS image, . . . , and a xA_{z-1} WS image.

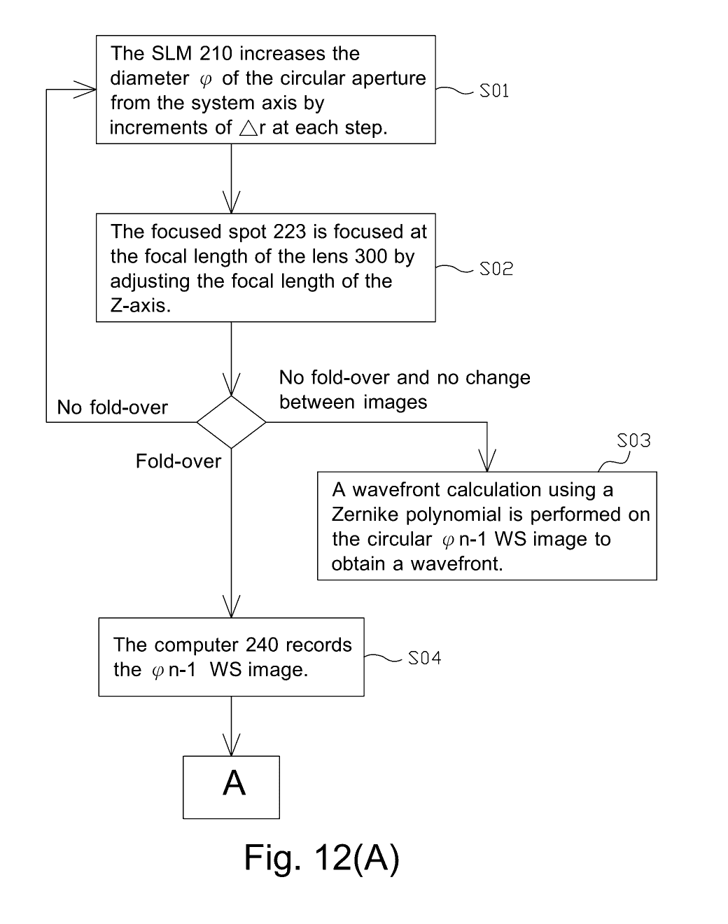

FIG. 10(A) is a schematic illustration of the variation of different wavefronts before the wavefronts are stitched. Then, the variation of different wavefronts may be obtained by performing wavefront calculation on the above-mentioned WS images, as shown in FIG. 10(A).

FIG. 10(B) is a schematic illustration of the whole wavefront variation information after the wavefronts of FIG. 10(A) are stitched. As shown in FIGS. 10(A) and 10(B), after the above-mentioned WS images are obtained by the above processes, a plurality of kinds of algorithms may be used to stitch the wavefronts of the above-mentioned WS images, so that the whole wavefront variation information is obtained. The algorithms may be a phase stitching algorithm (PSA), a gradient stitching algorithm (GSA) or a least-square fitting (LSF).

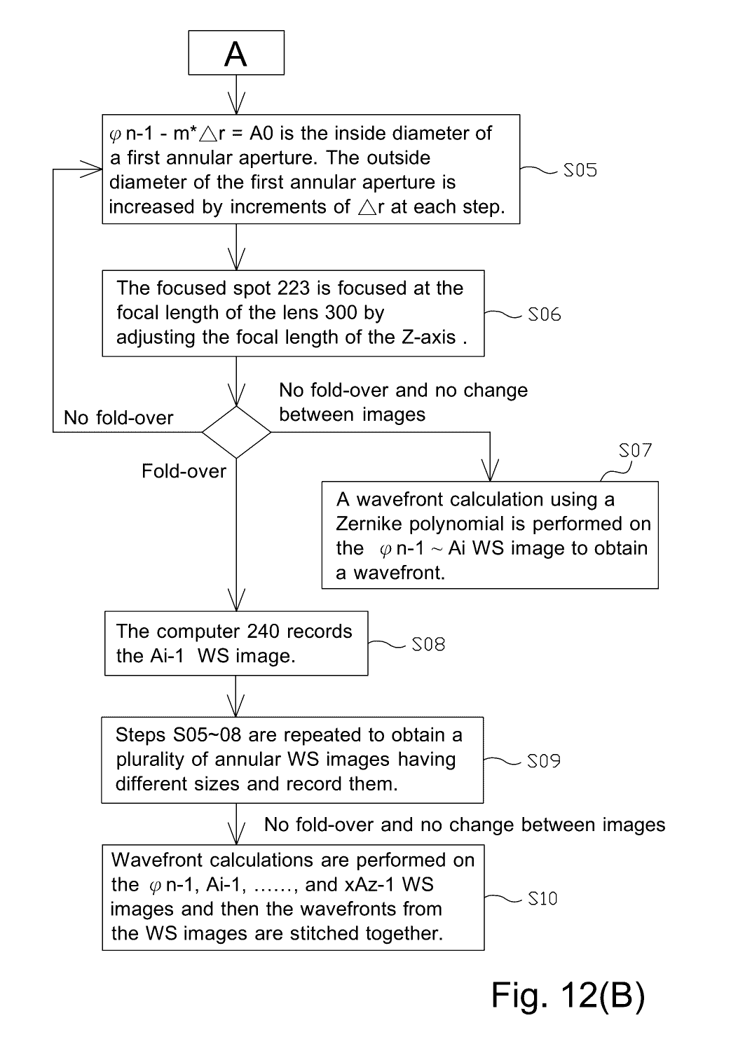

Finally, the wavefront of the whole pupil is rebuilded, as shown in FIG. 11. FIG. 11 is a schematic illustration of the rebuilded wavefront obtained by using the whole wavefront variation information in FIG. 10(B).

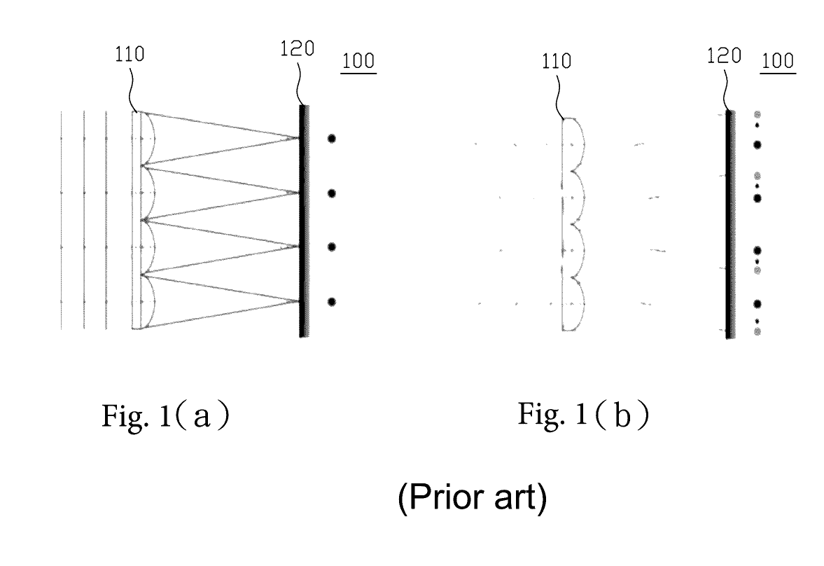

An optical wavefront measuring method according to an embodiment of the present invention will be described in the following. FIGS. 12(A) and 12(B) are flow charts of an optical wavefront measuring method according to an embodiment of the present invention. As shown in FIG. 12(A), the optical wavefront measuring method includes the following steps. The SLM 210 increases the diameter φ of the circular aperture from the system axis by increments of Δr at each step (Step S01). The focused spot 223 is focused at the focal length of the lens 300 by adjusting the focal length of the Z-axis (Step S02). It is confirmed that whether the WS images have a fold-over phenomenon and whether there is a change between the φ and φₙ₋₁ WS images. If the WS images have not a fold-over phenomenon, the method returns back to step S01; if the WS images have not a fold-over phenomenon and there is not a change between the φ and φₙ₋₁ WS images, the method goes to next step S03. A wavefront calculation using a Zernike polynomial is performed on the circular φₙ₋₁ WS image to obtain a wavefront (Step S03). If the WS images have a fold-over phenomenon, the method goes to next step S04. The computer 240 records the φₙ₋₁ WS image (Step S04).

As shown in FIG. 12(B), φₙ₋₁−m*Δr=A₀ is the inside diameter of a first annular aperture. The outside diameter of the first annular aperture is increased by increments of Δr at each step (Step S05). The value of m corresponds to the size of the overlap region. The focused spot 223 is focused at the focal length of the lens 300 by adjusting the focal length of the Z-axis (Step S06). It is confirmed that whether the WS images have a fold-over phenomenon and whether there is a change between the Aᵢ and Aᵢ₋₁ WS images. If only the WS images have not a fold-over phenomenon, the method returns back to step S05; if the WS images have not a fold-over phenomenon and there is not a change between the Aᵢ and Aᵢ₋₁ WS images, the method goes to next step S07. A wavefront calculation using a Zernike polynomial is performed on the φₙ₋₁˜Aᵢ WS image to obtain a wavefront (Step S07). If the WS images have a fold-over phenomenon, the method goes to next step S08. The computer 240 records the Aᵢ₋₁ WS image (Step S08).

Finally, steps S05˜08 are repeated to obtain a plurality of annular WS images having different sizes and record them (Step S09). When the WS images have not a fold-over phenomenon and there is not a change between the xA_{z} and xA_{z-1} WS images, the method goes to next step S10. Wavefront calculations are performed on the φₙ₋₁, Aᵢ₋₁, . . . , and xA_{z-1} WS images and then the wavefronts from the WS images are stitched together to rebuild a complete wavefront of the whole pupil.

As above, according to an embodiment of the present invention, different WS images without a fold-over phenomenon are obtained; the wavefronts from the WS images are stitched; the wavefront aberrations after stitching are obtained; then a complete wavefront can be rebuilt. As a result, the problem of the fold-over phenomenon can be resolved, which occurs under high aberrations due to lateral displacement, so that the optical wavefront measuring device and method of the present invention are suitable for testing an aspherical lens.

What is claimed is:

1. An optical wavefront measuring device for testing a lens under test, comprising a spatial light modulator (SLM), a wavefront sensor, an infinite objective lens module and a computer, wherein
the SLM is used to produce different apertures, whereby different light beams passing through the apertures form a plurality of light patterns,
the infinite objective lens module is used to adjust the distance between the infinite objective lens module and the lens under test, whereby the light patterns passing through the lens under test and the infinite objective lens module become approximately parallel and then enter into the wavefront sensor,
the wavefront sensor is used to capture a plurality of WS images on the basis of the light patterns, wherein the WS images do not have a fold-over phenomenon, and
the computer is used to stitch the WS images by using an algorithm to obtain a wavefront variation information, and then to rebuild a complete wavefront on the basis of the wavefront variation information.

2. The optical wavefront measuring device according to claim 1, further comprising a parallel light source system used for generating the light beams being parallel.

3. The optical wavefront measuring device according to claim 1, wherein
the infinite objective lens module comprises an infinite objective lens and an actuator,
the light patterns sequentially pass through the infinite objective lens module and the lens under test,
the light patterns passing through the infinite objective lens form a plurality of focused spots, and
the actuator is used to adjust the distance between the infinite objective lens and the lens under test, so that the focused spots are focused at the focal length of the lens under test.

4. The optical wavefront measuring device according to claim 1, wherein
the infinite objective lens module comprises an infinite objective lens and an actuator,
the light patterns sequentially pass through the lens under test and the infinite objective lens module,
the light patterns passing through the lens under test form a plurality of focused spots, and
the actuator is used to adjust the distance between the infinite objective lens and the lens under test, so that the focused spots are focused at the focal length of the infinite objective lens.

5. The optical wavefront measuring device according to claim 1, wherein the algorithm is a phase stitching algorithm (PSA), a gradient stitching algorithm (GSA) or a least-square fitting (LSF).

6. The optical wavefront measuring device according to claim 1, wherein
the apertures include a circular aperture and a first annular aperture being concentric with each other, and
the inside diameter of the first annular aperture is not larger than the diameter of the circular aperture.

7. The optical wavefront measuring device according to claim 6, wherein
the apertures further include a second annular aperture being concentric with the first annular aperture, and
the inside diameter of the second annular aperture is not larger than the outside diameter of the first annular aperture.

8. An optical wavefront measuring method for testing a lens under test, the method comprising:
using a SLM to produce different apertures, whereby different light beams passing through the apertures form a plurality of light patterns;
using an infinite objective lens module to adjust the distance between the infinite objective lens module and the lens under test, whereby the light patterns passing through the lens under test and the infinite objective lens module become approximately parallel and then enter into a wavefront sensor;
using the wavefront sensor to capture a plurality of WS images on the basis of the light patterns, wherein the WS images do not have a fold-over phenomenon; and
using a computer to stitch the WS images by using an algorithm to obtain a wavefront variation information, and then to rebuild a complete wavefront on the basis of the wavefront variation information.

9. The optical wavefront measuring method according to claim 8, wherein
the apertures include a circular aperture and a first annular aperture being concentric with each other, and
the step of using a SLM to produce different apertures comprises:
increasing the diameter of the circular aperture by increments of Δr at each step until n-th step at which the WS image corresponding to the circular aperture has a fold-over phenomenon, and setting the diameter of the circular aperture to be the diameter φₙ₋₁ at (n-1)-th step,
setting the inside diameter A₀ of the first annular aperture to be not larger than the diameter φₙ₋₁ of the circular aperture, and
increasing the outside diameter of the first annular aperture by increments of Δr at each step until i-th step at which the WS image corresponding to the first annular aperture has a fold-over phenomenon, and setting the outside diameter of the first annular to be the diameter Aᵢ₋₁ at (i-1)-th step.

10. The optical wavefront measuring method according to claim 9, wherein the apertures further include a second annular aperture being concentric with the first annular aperture, and
the step of using a SLM to produce different apertures further comprises:
setting the inside diameter 2A₀ of the second annular aperture to be not larger than the outside diameter A of the first annular aperture, and
increasing the outside diameter of the second annular aperture by increments of Δr at each step until I-th step at which the WS image corresponding to the second annular aperture has a fold-over phenomenon, and setting the outside diameter of the second annular to be the diameter 2A_{I-1} at (I-1)-th step.

11. The optical wavefront measuring method according to claim 8, wherein the algorithm is a phase stitching algorithm (PSA), a gradient stitching algorithm (GSA) or a least-square fitting (LSF).
